(19) United States
(12) Patent Application Publication
(10) Pub. No.: US 2013/0297426 A1
(43) Pub. Date: Nov. 7, 2013

(54) INSERTION OF USER-GENERATED CONTENT (UGC) INTO ADVERTISEMENTS BASED ON CONTRIBUTOR ATTRIBUTES

(71) Applicant: Bazaarvoice, Inc., Austin, TX (US)

(72) Inventors: Matthew G. Marx, Austin, TX (US); Lasantha Indrajith Kularatne, Austin, TX (US); Michael Lewis, Woodinville, WA (US); Nathaniel R. Baurnfeind, Austin, TX (US)

(21) Appl. No.: 13/859,491

(22) Filed: Apr. 9, 2013

Related U.S. Application Data
(60) Provisional application No. 61/622,413, filed on Apr. 10, 2012.

(51) Int. Cl. G06Q 30/02

(52) U.S. Cl. CPC G06Q 30/0269
USPC 705/14.66

(57) ABSTRACT

User-generated content (UGC) may be dynamically inserted into an advertisement (such as a web advertisement) or other media. UGC may be selected for insertion based on attributes of a target user or viewer (e.g., a person who will view an advertisement in a web browser). UGC may also be selected based on attributes of a contributor of UGC. For example, UGC authored by an expert male video-game player may be selected for insertion in an advertisement that is targeted to users who may be likely to be influenced by such a person. Conversely, target users that may not be a good match with a given contributor may not have content from the given contributor presented to them in an advertisement or other media. Weighted scoring mechanisms may determine whether a contributor of UGC is considered to be a match for a target user.

This application claims the benefit of U.S. Provisional Application No. 61/622,413, filed Apr. 10, 2012, which is incorporated by reference herein in its entirety.

### BACKGROUND

Today's consumer is often inundated with advertising. Consumers may trust word-of-mouth content (i.e., user-generated content, or UGC), from people like themselves, about goods and services, however, more than traditional advertising. In fact according to a 2007 global Nielsen survey, consumer recommendations are a relatively credible form of advertising, as cited by the study's respondents. When businesses enable customers, or other types of users, to write reviews, ask or answer questions from the community, share experiences, etc., corresponding contributor content that results may become useful in powerful forms of marketing.

Word-of-mouth content that is used statically in an advertisement, however, may have shortcomings. For example, hard-coding particular information into an advertisement may result in users seeing that particular information repeatedly, which may cause it to be less effective. Further, hard-coded (e.g., static) word-of-mouth content may have little relevance to a particular user that is viewing that content. For example, a young mother of three may be unlikely to be influenced by information contributed by an elderly gentleman who lives across the country and has no children. His opinion simply may not be relevant to her when she is considering, for example, a purchase of a new automobile, or other good or service.

### BRIEF DESCRIPTION OF THE DRAWINGS

The drawings accompanying and forming part of this specification are included to depict certain aspects of the invention, and correspond to various non-limiting embodiments. Features illustrated in the drawings are not necessarily drawn to scale.

FIG. 1 is a diagram of one embodiment of a system for distributing word-of-mouth (WOM) content.

FIG. 2 is a diagram of one embodiment relating to the distribution of advertisements (or other content) that incorporate UGC.

FIG. 3 is a diagram of one embodiment relating to a process flow through a WOM system usable to cause WOM content (i.e., UGC) to be inserted into an advertisement or other media.

FIGS. 4 and 5 are diagrams illustrating embodiments of advertisements that incorporate selected UGC.

FIG. 6 is a diagram of one embodiment of an advertisement in which other data derived from WOM content (i.e., UGC) may be provided.

FIGS. 7 and 8 are flowcharts of embodiments of methods that relate to dynamically inserting word-of-mouth content (e.g., inserting UGC into an advertisement).

FIG. 9 is a flowchart of one embodiment of a method relating to selecting and/or pre-selecting WOM content that matches target user data.

FIG. 10A is a block diagram that relates to one embodiment of mapping contributor attributes to target attributes (e.g., for an ad campaign).

FIG. 10B is a diagram illustrating a table in which attribute value match scores have been calculated for target attribute value/contributor attribute value pairs.

FIG. 10C is a diagram illustrating example contributors and example end users.

FIG. 11 is a diagram of one embodiment of a content collection topology including a content system.

FIG. 12 is a diagram of one embodiment of a computer system.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

Various units, circuits, or other components may be described or claimed herein as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not powered on). The units/circuits/components used with the “configured to” language include hardware—for example, circuits, memory storing program instructions executable to implement the operation(s), etc. Reciting that a unit/circuit/component is “configured to” perform one or more tasks is expressly intended not to invoke 35 U.S.C. §112(f) (formerly, sixth paragraph) for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue.

As used herein, terms such as “first,” “second,” etc. are used as labels for nouns that they precede, and, unless otherwise noted, do not imply any type of ordering (e.g., spatial, temporal, logical, etc.) for those nouns. Thus, a “first” attribute and a “second” attribute can be used to refer to any two attributes, for example.

Still further, the terms “based on” and “based upon” are used herein to describe one or more factors that affect a determination. These terms do not foreclose additional factors that may affect a determination. That is, a determination may be solely based on the factor(s) stated or may be based on one or more factors in addition to the factor(s) stated. Consider the phrase “determining A based on B.” While B may be a factor that affects the determination of A, this phrase does not foreclose the determination of A from also being based on C. In other instances, however, A may be determined based solely on B.

### DETAILED DESCRIPTION

The invention and the various features and advantageous details thereof are explained more fully with reference to the non-limiting embodiments that are illustrated in the accompanying drawings and detailed in the following description. Various substitutions, modifications, additions and/or rearrangements within the spirit and/or scope of the underlying inventive concept will become apparent to those skilled in the art from this disclosure. Embodiments discussed herein can be implemented in suitable computer-executable instructions that may reside on a computer readable medium (e.g., a hard disk (HD)), hardware circuitry or the like, or any combination.

Additionally, any examples or illustrations given herein are not to be regarded in any way as restrictions on, limits to, or express definitions of, any term or terms with which they are utilized. Instead, these examples or illustrations are to be regarded as being described with respect to one or more particular embodiments and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such non-limiting examples and illustrations includes, but is not limited to: “for example,” “for instance,” “e.g.,” “in one embodiment”, etc.

As used herein, the term word-of-mouth (“WOM”) content includes user-generated content (“UGC”) such as ratings, reviews, comments, answers, stories, or other types of content that may be submitted by a contributor (e.g., a website visitor). WOM content may be in one or more formats such as text, image, video, audio, or other forms of data. One of skill in the art would therefore understand that WOM content (i.e., UGC) may be generated by a user who may be a consumer of something (e.g., of goods, a product, a website, a service), a purchaser of that something, or who may otherwise have an interest in that something. Accordingly, WOM content may be associated with products (e.g., individual products, categories, brands, services, etc.) and contributor records. Thus, each piece of WOM content (i.e., item of UGC) may be tied to a product and contributor, in various embodiments.

In various embodiments described herein, a WOM distribution system (i.e., a UGC distribution system) may dynamically insert WOM content (i.e., UGC) that is related to an individual good, individual service, brand, category of good, category of service (each referred to generically as a product) into advertisements or other media. Accordingly, as used herein, the term “product” may refer, in various embodiments, to a good, a service, a brand associated with a good and/or service, a category of goods (e.g., monitors), a service category (e.g., automotive repairs), etc. WOM content may be dynamically inserted based on a match between the WOM content and a target user. In one embodiment, a match between WOM content and a target user is established based on a match between a contributor of the WOM content and the target user, as discussed below.

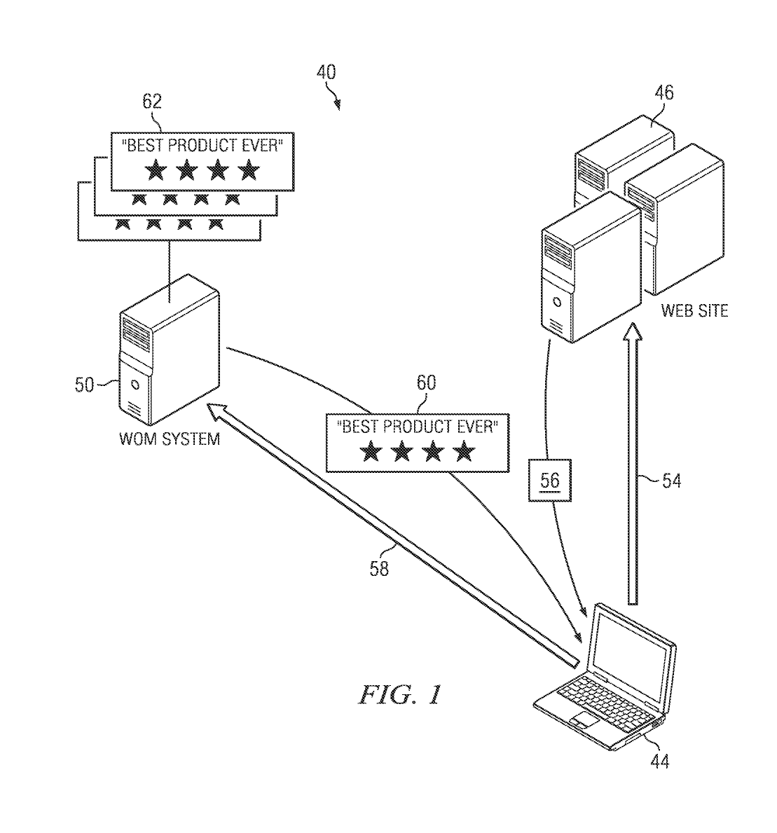

Turning now to FIG. 1, a diagram is shown of one embodiment of a system 40 for distributing WOM content. In the embodiment shown, system 40 includes one or more client devices 44, site servers 46 and WOM system 50. Client device 44 may, in various embodiments, be any suitable computing device such as a mobile phone, laptop, desktop, server, or other device. Site servers 46 include one more servers configured to provide a network accessible site (e.g., a website). WOM system 50 includes one or more computing devices, in various embodiments, that are configured to provide (e.g., distribute) WOM content to another system (e.g., website servers 46, clients 44, ad servers, etc.).

In some embodiments, client device 44 is configured to send a request 54 to a website server 46 and receive a web page 56 in response. In response to website server 46 receiving request 54, it may initiate any number of events in various embodiments, including the generation of dynamic content that is customized for a requesting user. In some embodiments, website server 46 may issue one or more ad requests to request ad content for incorporation into page 56 prior to sending page 56 to client device 44, while in other embodiments, website server 46 may send page 56 with components (e.g., embedded code, scripts, other content, etc.) that cause client device 44 to make a request 58 that is directed toward WOM system 50. In such embodiments, client device 44 may incorporate returned content into page 56 for local rendering. In one embodiment, a request from client device 44, site server(s) 46, ad servers, or other systems are received by WOM system 50, which may provide WOM content 60 in response (e.g., for use in an advertisement, or for incorporation with other content).

WOM content 60 may be selected to match a target user in various embodiments. For example, a user may have a user profile (e.g., defined using one or more websites) that includes various user information. In some embodiments, the user profile may be created and/or modified using one or more websites (or other system) that may actively or passively collect (possibly in cooperation with other services) information about a user, such as browsing habits, location, interests, etc. Such user information may be provided to WOM system 50 in various embodiments, which may use this information to match WOM content (i.e., UGC) to a particular user.

Request 58 (from client device 44) may include information regarding a relevant product as well as target user information (e.g., information from a user profile or other information about the user), in various embodiments. For example, request 58 may be a request for WOM content that is associated with a certain model of television, and may indicate that a target user is a male and is a gamer (e.g., the user profile of the user of client device 44 indicates a male gamer based on, for example, browsing or purchasing behavior). Accordingly, WOM system 50 may match WOM content 60 to information in request 58 (or other information) in order to provide specific content that may be relevant to a target user having certain characteristics. In one embodiment, WOM system 50 may determine a pool of UGC items (e.g., WOM content 62) to be considered as a match for a target user, and may select one or more particular pieces of content from that pool to provide in response to request 58. In one embodiment, one or more items of WOM content (i.e., UGC) may be selected for inclusion in pool 62 based on a match between one or more contributors of WOM content and a target user.

In various embodiments, WOM content 60 may be included in a web advertisement, a portion of a social media page, a portion of a website's ratings and review page, an email, connected television content, a text, a video, content in an app, content at a mobile or tablet device or other connected media. In some embodiments, a request for WOM content request may be received from one system and WOM content 60 may be provided to another system. For example, a WOM content request may be received through a web request and resulting WOM content 60 may be included in a marketing email or a text, for example.

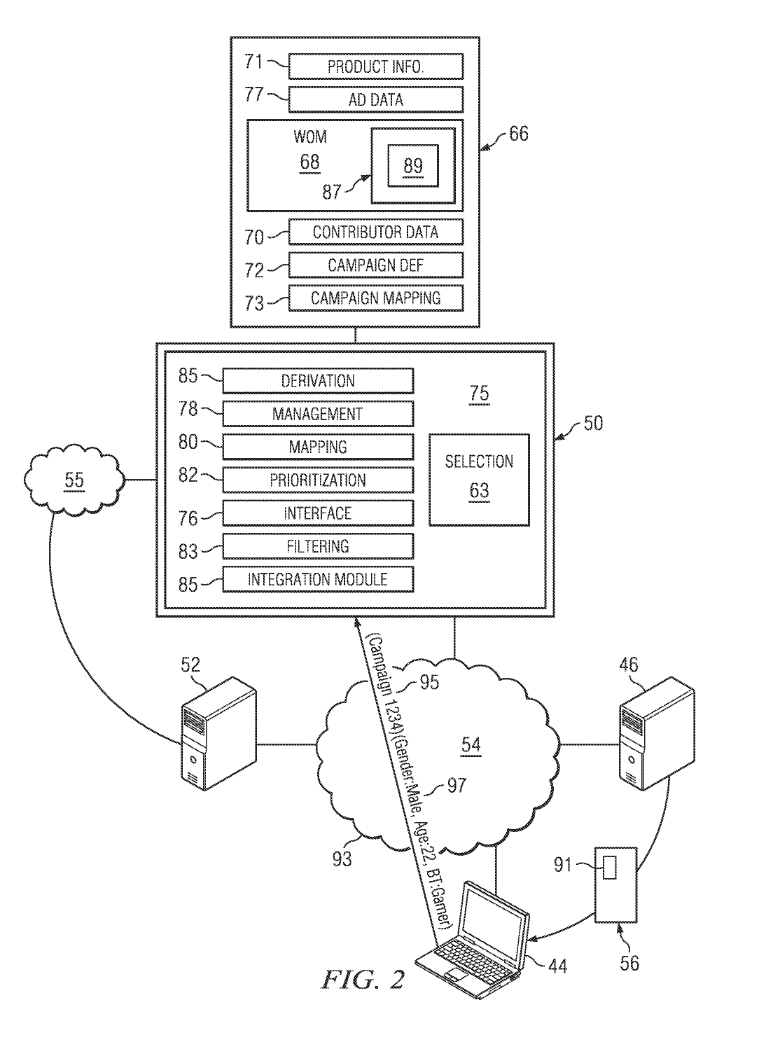

Turning now to FIG. 2, a diagram is shown of one embodiment relating to the distribution of advertisements (or other content) that incorporate UGC. As shown, FIG. 2 includes client device 44, site server 46, WOM system 50 and content system 52, which may communicate via one or more networks 54 and/or 55 (which may include the Internet in various embodiments). WOM system 50 may include one or more computers configured to access data store 66, which includes WOM content 68, contributor data 70, product id information 71, campaign definitions 72, campaign mappings 73 and ad data 77 in the embodiment of FIG. 2.

Contributor data 70 may, in various embodiments, include demographic information, financial information, or any other information related to a contributor of UGC. According to one embodiment, contributors can be associated with segments (age, income, channel usage (e.g., manner in which the user purchases products such as direct/online only, retail only, both), persona (e.g., tech savvy or other arbitrary persona assigned to a user) or other segment). Segments can be provided directly from contributors, derived from information submitted by contributors when submitting UGC, imported from customer relationship management data or other otherwise determined.

Product id information 71 may, in various embodiments, include product, service, category identifiers or catalogs so that UGC collected from different sources can be correlated to the same product. For example, in some embodiments, a catalog may comprise a set of category identifiers utilized by a retailer or manufacturer (e.g., a provider of a product), where each category identifier may be associated with one or more product identifiers and each product identifier may be, in turn, associated with a brand name, a product name, or any number of other desired attributes. A catalog may, for example, comprise one or more files of eXtensible Markup Language (XML), JSON, etc. Product id information 71 may further include, in some embodiments, any mappings between identifiers used by different retailers (or other sources of UGC) so that different product IDs used by different sources (e.g., different retailers) to indicate a same product may be correlated as corresponding to the same product.

In some embodiments, a campaign definition 72 specifies a product and target(s) of an advertising campaign and other campaign information. A campaign definition may specify various criteria (e.g., only 4 star reviews or better are to be used, only reviews from certain sources are to be used, etc.). A campaign mapping 73 may provide correlations that allow WOM content 68 to be matched with target users, in one embodiment.

Ad data 77 can include data for integrating UGC into ads, in some embodiments. Ad data can be linked to campaigns so that certain ad data is used for one campaign and other ad data is used for other campaigns. Ad data can provide, for example, an ad template into which WOM content (i.e., UGC) is incorporated (e.g., when WOM system 50 serves a complete ad) or information provided to other systems to facilitate integration of WOM content into an ad.

WOM system 50 may also include a WOM content distribution application 75, in one embodiment, which may receive requests from ad servers, site servers, client devices or other systems for WOM content, and be configured to process requests and to provide relevant WOM content in response. In some embodiments, WOM content distribution application 75 may include an interface module 76, a campaign management module 78, a mapping module 80, a content filtering module 81, a prioritization engine 82, a selection engine 63, an integration module 83 and a derivation module 85.

In the embodiment of FIG. 2, interface module 76 may process requests to pass relevant information to various software modules and provide responses in an appropriate format. In one embodiment, interface module 76 may provide an API through which other systems can interface with WOM system 50. In one embodiment, campaign management module 78 allows campaign definitions 72 to be created. A campaign definition 72 may specify a product being advertised, target attributes and attribute values, UGC criteria (e.g., only reviews with a 4 star minimum), or other criteria for the campaign. Campaigns can also be defined to govern the distribution of WOM content to target users in a non-advertising context, in various embodiments.

In one embodiment, mapping module 80 allows for the creation of mappings used to determine which WOM content 68 should be provided based on target user data. In some embodiments, mapping module allows campaign mappings 73 to be defined that map contributor attributes to target attributes so that contributors can be matched to target user data, for example. Thus, mapping module 80 may provide an interface in some embodiments through which a user can map contributor attributes to target attributes, which may allow selection of WOM content based on a match between a contributor and target user. In other embodiments, mapping can be performed programmatically.

In one embodiment, prioritization engine 82 is configured to determine a measure of the relative relevance of a piece of WOM content 68 to a target user based on the target user data. According to one embodiment, this may include determining a measure of how well one or more contributors of UGC match the target user data (e.g., with the assumption that UGC submitted by a well matching contributor will be more relevant to a target user than UGC submitted by a poorly matching contributor). Note that matches, in some embodiments, are not necessarily based on whether target user attributes are identical to contributor attributes.

In one embodiment, filtering module 83 is configured to select WOM content based on campaign definition 72, product id information 71 and other information. Thus, filtering module 83 can determine WOM content 68 relevant to a campaign based on a product specified in the campaign, product id information 71 and associations between WOM content 68 and product id(s), etc., in some embodiments. Filtering module 83 may also filter content based on criteria specified for the campaign, such as only selecting reviews with a minimum of four stars for use with a campaign. Additionally, content may be filtered based on the attributes of contributor of that content, in some embodiments. For example, for a campaign aimed at golf experts, content from users classified as beginners may be filtered out. Thus, for a given campaign, filtering module 83 may specify a set of filtered WOM content 87 that includes UGC associated with a product and that meets other criteria of the campaign, in various embodiments. Accordingly, in some scenarios, some particular items of UGC may never be considered for inclusion in an advertisement or other media.

In the embodiment of FIG. 2, selection engine 63 is configured to receive a measure of the relative relevance of WOM content from prioritization engine 82 and select a pool 89 of one or more pieces of filtered WOM content that match target user data. Thus, in one embodiment, selection engine 63 may receive a list of (best) matching contributors or contributor rankings for contributors of filtered WOM content 87, and identify WOM content submitted by the matching contributors for inclusion in pool 89. Thus, selection module 63 may identify product-specific content, meeting specified criteria and contributed by certain contributors to provide to a target user, in some embodiments.

In some embodiments, prioritization engine 82 can perform pre-prioritization of filtered WOM content 87. If there are only a limited number of target user profiles that are of interest in a given campaign, prioritization engine 82 can determine the measure of relative relevance of filtered WOM content 87 for each of those profiles. Selection engine 63 may, in some embodiments, then pre-select which filtered WOM content 87 best matches the target user profiles, thereby pre-selecting WOM content pool 89 for target users that meet a target user profile.

In one embodiment, derivation module 85 can create derived WOM content from filtered content 87, including from pool 89. For example, derivation module 85 may determine the average star rating of a product from an overall set of WOM content 68. As another example, derivation module may derive one or more most common uses of a product from WOM content provided by all the contributors of content in WOM pool 89.

Integration module 83 may, in some embodiments, integrate selected WOM content, including derived WOM content, with ad data. In some embodiments, the ad data may be relatively static or selected based on some attributed aspect of the target user. The ad data may include an ad template into which WOM content is inserted, or other data (e.g., metadata) for integrating a piece of WOM content into an advertisement at WOM system 50 (or another system, such as user device 44).

In one embodiment, web site server 46 is configured to provide a web page 56 to client device 44 that includes an ad unit 91. Ad unit 91 may provide space on a web page where ads are displayed, and be processed by a web browser to provide a display interface through which the ad content is rendered as part of the rendered web page. Thus, in certain embodiments, when web page 56 is loaded on a web browser at client device 44, web page 56 includes a script or other mechanism (e.g., executable code) by which a request 93 for WOM content is made to WOM system 50. Request 93 may include a campaign identifier 95 (or other identifier that can be used to identify a product) and a set of target user information 97 in some embodiments (which may include information about the target user relevant to an ad, and may include multiple parameters associated with a user).

In response to request 93, in one embodiment, WOM system 50 is configured to identify the pool of WOM content 89 that is considered to be most relevant to the target user data in the target user information 97. WOM content 89 may be identified “on the fly” in some embodiments, or be preselected as being relevant to the target user data. If there are multiple pieces of WOM content (e.g., items of UGC) in pool 89, WOM system 50 can select particular pieces of the relevant WOM content from pool 89 according to various rules in various embodiments, such as frequency rules or other rules that may be used to maintain a small variety of word of mouth content provided from among the most relevant content determined by the system. (In other embodiments, the most relevant piece of content can be provided repeatedly.)

Selected WOM content may be integrated with ad data 77 in various embodiments. In one embodiment, WOM system 50 may return a selected piece or pieces of WOM content with metadata identifying attributes of the associated contributor and other data for dynamic insertion into advertising unit 91 (e.g., at a display interface). Furthermore, in addition to providing WOM content, in some embodiments, WOM system 50 may provide data derived from filtered WOM content 87, such as an average rating or other derived WOM information.

Because the selected WOM content, in one embodiment, appears as part of a web advertisement, the selected WOM content may be provided in a manner that does not appreciably slow page rendering. Therefore, WOM system 50 can be configured to prioritize potentially thousands of pieces of content (or contributors) so that selected content can be returned within the time of rendering web page 56 at the browser such that the end user experiences no perceivable delay in viewing the web page in some embodiments.

In the embodiment of FIG. 2, ad unit 91 is provided by site server 46. In other embodiments, ad unit 91 may be provided by an ad server or other system such that client device 44 downloads the initial information for web page 56, requests the ad unit and then issues request 93 to WOM system 50. In yet other embodiments, an ad server, site server 46 or other system requests the WOM content from WOM system 50 and provides the WOM content to client 44, web site server 46, ad server etc.

WOM system 50 may have access to a large amount of UGC from a large number of contributors collected by content system 52 for incorporation as WOM content 68. In some embodiments, not all portions of collected UGC becomes WOM content 68—that is, a snippet of text (e.g., that conveys a sentiment of a review) may be selected manually or programmatically from UGC to be part of WOM content 68. Accordingly, UGC that is included in an advertisement or other media may be less than an entirety of UGC that was submitted by a contributor (that is, some portions of UGC may be omitted). In some embodiments, UGC not meeting any campaign objectives may be rejected based on other criteria, such as insufficient rating, inappropriate content, etc.

In one embodiment, if full reviews are part of WOM content 68, the reviews can be provided to the end-user while minimizing the screen real estate used to provide WOM content to the end-user. For example, when a particular piece of WOM content 68 is selected for dynamic insertion, a portion of the review can be selected for initial rendering, such as a snippet of text that conveys the authentic sentiment of the review. The entire review may be provided, in various embodiments, through a link, mouse over event, popup, etc. In this case, an end-user may initially see the snippet, but can access the remainder of the review (e.g., through interaction with the inserted content).

The functions described above relative to FIG. 1 and FIG. 2 can be distributed or executed according to different configurations in various embodiments. In some embodiments, WOM system 50 and content system 52 may share hardware, software, or other components (i.e., all or a portion of systems 50 and 52 may be integrated). All or a portion of WOM system 50 may also be integrated as part of a website, an ad server system, rating and review system, or other system, in various embodiments. In some embodiments, WOM system 50 may provide WOM content for inclusion in content other than web advertisements, such as in emails, social networking posts, texts, content delivered to mobile and tablet devices, in videos, connected television content or other media.

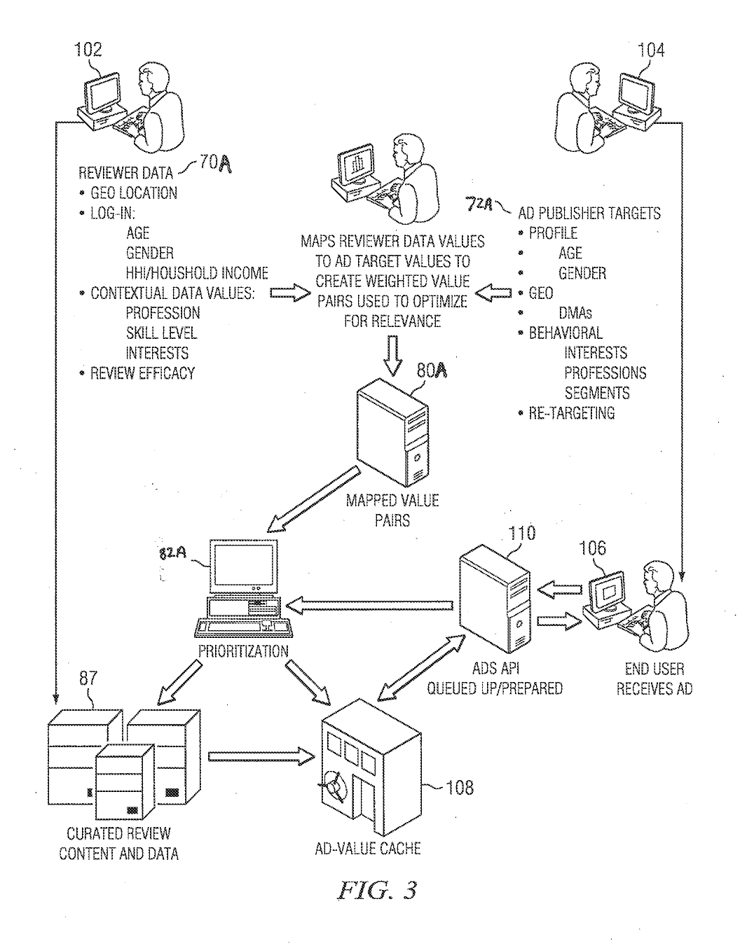

Turning now to FIG. 3, a diagram is shown of one embodiment relating to a process flow through a WOM system usable to cause WOM content (i.e., UGC) to be inserted into an advertisement (or other media). In this embodiment, reviewer 102 may input one or more pieces of UGC and one or more sets of contributor data 70A. Contributor data 70A may include one or more aspects relative to contributor data 70A as described above relative to FIG. 2. Accordingly, contributor data 70A may include, but is not limited to, in various embodiments, a reviewer's geographic location; age, gender, household income, etc.; one or more contextual data values, such as profession, skill level, interests, etc.; and one or more reviews. UGC may be moderated to remove personally identifiable information, phone numbers, inappropriate content, etc., in various embodiments.

In one embodiment, (e.g., in a campaign setup phase), an advertiser 104 may define a product that the advertiser wishes to advertise, the target(s) of one or more advertisements (e.g., criteria defining various attributes relating to preferred targets of an advertisement campaign), and other criteria for the campaign (e.g., only 4 star and above reviews, only reviews from certain domains, etc.). In some embodiments, advertiser 104 may specify target attributes and values, and a corresponding campaign definition 72A may be stored. Additionally, in various embodiments, campaign mappings 80A can be established. In one embodiment, contributor attributes can be mapped to target attributes to create a mapping 80A used to match filtered WOM content 87 with target user data.

In one embodiment, a prioritization engine (e.g., as implemented by prioritization engine system 82A) can calculate a measure of the relative relevance of WOM content 87 to target user data. According to one embodiment, for example, prioritization engine system 82A can determine which contributors of filtered WOM content 87 matches (e.g., best matches) the target user data for an end user 106 (e.g., contributors that match various attributes of the end user, and/or contributors that match various attributes of others that the end user may find to be of influential), and provide a measure of which WOM content matches (or best matches) the target user data. This prioritization can be done after or prior to receiving a request corresponding to end user 106, in various embodiments.

Based on a determination by prioritization engine 82 (e.g., as implemented by system 82A), a pool of WOM content can be selected as matching the target user data in one embodiment. In association with a request corresponding to end user 106 (e.g., a request for UGC to be inserted into an advertisement to be presented to the end user), in one embodiment, one or more pieces of WOM content that match the target user data can be selected from the pool of matching content for inclusion in an ad. Ad data can be provided or accessed from an ad-value cache 108 and merged with the selected WOM content (e.g., advertising images, audio, or other ad content may be integrated with UGC). An API 110 may send the merged ad to the end user 106.

Furthermore, in various embodiments, one or more pieces of WOM content can be selected for further processing, such as to create derived WOM content. The derived WOM content can be selected for inclusion in an ad, as discussed further below. Thus, embodiments of a WOM system can be used to dynamically inject WOM content into advertisements aimed at targeted end users.

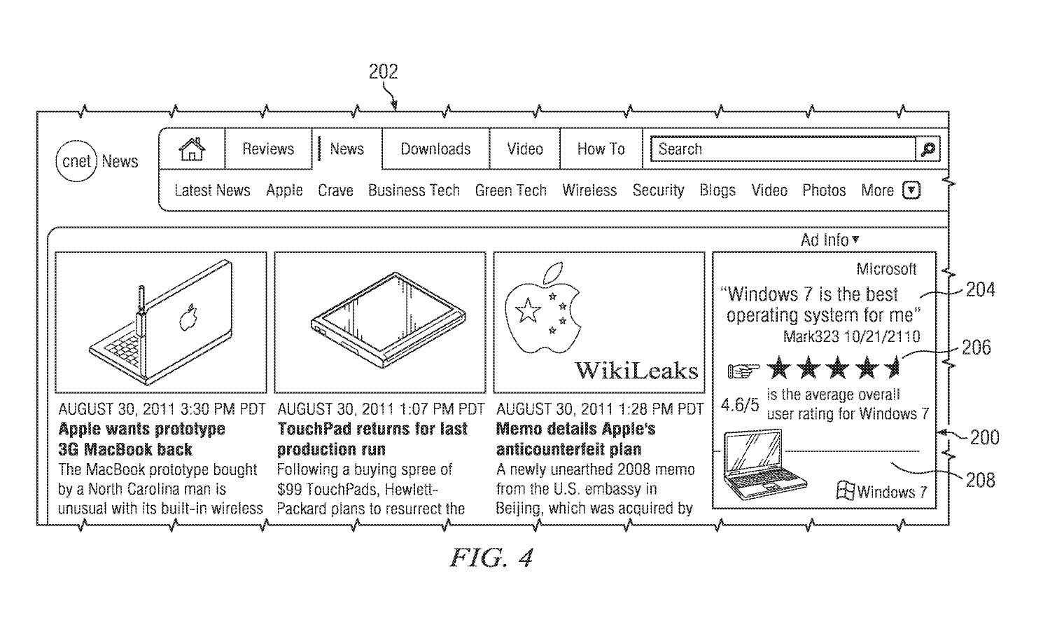

Turning now to FIG. 4, a diagram illustrating one embodiment of an advertisement that incorporates selected UGC is shown. In the embodiment of FIG. 4, an advertisement 200 for the WINDOWS 7 operating system (by MICROSOFT) is targeted for an end user browsing a page 202. In this embodiment, the end user is associated with user data indicating a “Profession” of “Student” and a “Segment” of “Gamer” (e.g., someone who plays computer games). As depicted in the embodiment of FIG. 4, advertisement 200 includes inserted UGC that comprises text 204 and rating 206 (which correspond to a contributor “Mark323”).

In one embodiment, text 204 and star rating 206 may be provided based on a match between UGC contributor “Mark323” and the target end user data “Student” and “Gamer”. Thus, text 204 and rating 206 are provided based on a person-to-person match between Mark323 and the end user, in one embodiment (though Mark323 may not be the only person to “match” the end user in some embodiments, and also may not necessarily be the “best” match for the end user in some embodiments). A different end user who views page 202 may receive some of the same aspects of ad content 208 (e.g., an ad for WINDOWS 7), but with different WOM content integrated into the ad based on one or more different matches.

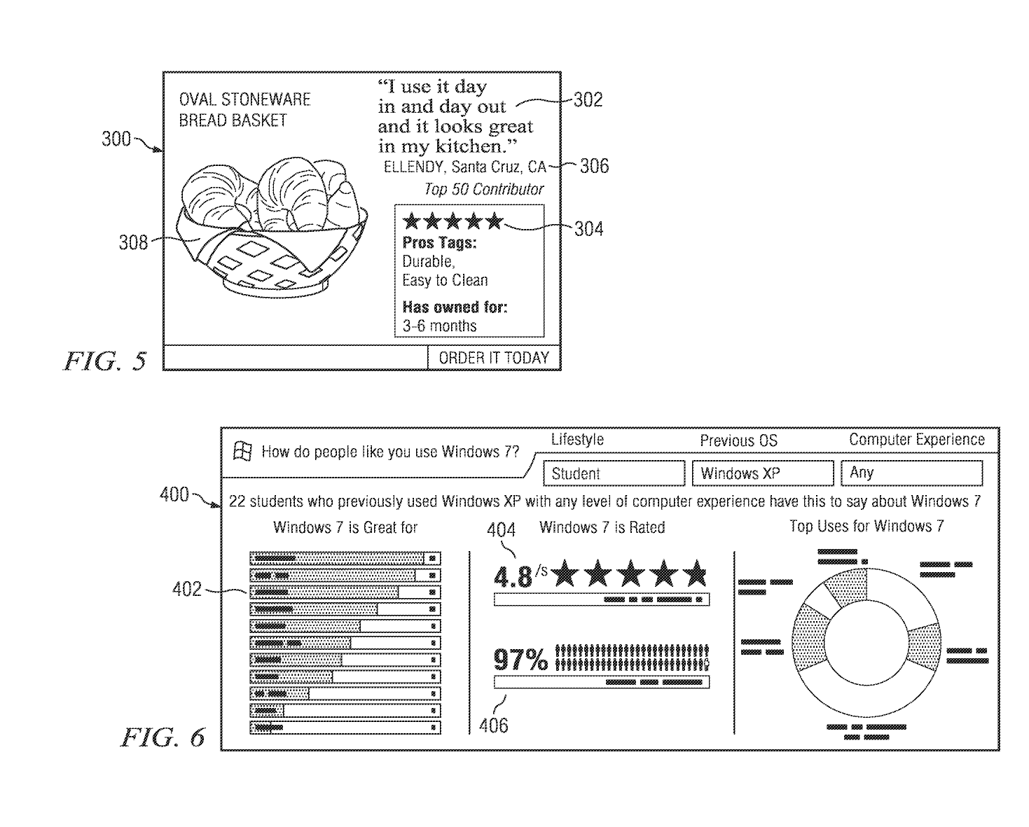

Turning now to FIG. 5, another diagram of an embodiment of an advertisement that incorporates selected UGC is shown. In this embodiment, advertisement 300 for a stoneware pottery bread basket is being targeted to end users associated with the target attribute “female.” Advertisement 300 includes text 302 from a review, as well as rating information 304. The contributor of text 302 and rating information 304 is identified by user name, geographic area and expertise (at 306) in this embodiment. WOM content may be selected, in the embodiment of FIG. 5, based on the fact that a contributor is a female who contributes to the website often and may be in the same geographical area as the target user. A different target user—for example, a male from a different geographic area—may receive similar ad content 308, but with different UGC.

Turning now to FIG. 6, a diagram is shown of one embodiment of an advertisement in which other data derived from WOM content (i.e., UGC) may be provided (e.g., to a targeted end user). Advertisement 400 comprises an “info-graphic” in this embodiment, and is targeted to end users identified as “Students” who use the MICROSOFT “WINDOWS XP” operating system. Based on WOM content, advertisement 400 may provide information on how people (e.g., like the targeted user) employ a different operating system (WINDOWS 7). Accordingly, indicators of utility 402, rating 404, and recommendation data 406 may be derived from WOM content contributed by a number of contributors that match a target user. As shown in advertisement 400, for example, recommendation data 406 indicates that 97% of matching contributors recommended WINDOWS 7.

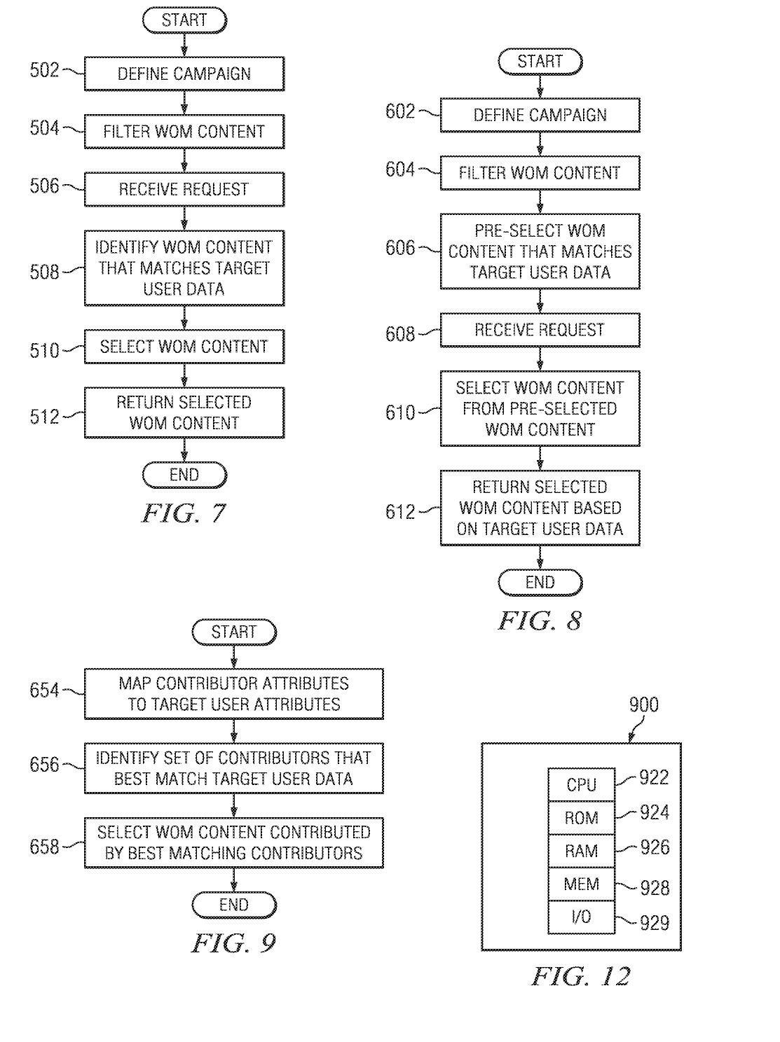

Turning now to FIG. 7, a flowchart is shown of one embodiment of a method that relates to dynamically inserting word-of-mouth content (for example, inserting UGC into an advertisement). As would be understood by one of skill in the art, all or a portion of each of the steps discussed relative to FIG. 7 may be executed by any capable system (e.g., WOM system 50 or another system).

In step 502, in one embodiment a campaign may be defined. As part of defining a campaign, various target user attributes (e.g., interests, age, gender, geography, profession, etc.) may be defined. In various embodiments, a product (e.g., good, service, brand, etc.) associated with the campaign may also be identified. In step 504, in one embodiment UGC associated with the product may be filtered (e.g., identified). In one embodiment, filtering UGC includes identifying particular UGC based on mapping various UGC to one or more unique product identifiers. UGC may be further filtered based on criteria specified by a particular campaign, in some embodiments.

In one embodiment, at step 506, a request can be received for WOM content (e.g., a UGC item) associated with a product, the request corresponding to a target user associated with target user data. For example, the request may include a product identifier, a campaign identifier or other identifier that can be mapped to a product and information about the target user relevant to the campaign.

In step 508, in one embodiment a pool of WOM content (e.g., pool 89) associated with a product that matches target user data is identified. In step 510, in one embodiment particular WOM content may be selected from identified WOM content (e.g., the pool from step 508) for inclusion in a response based on rules such as frequency rules or other rules so that, for example, the same piece(s) of WOM content do not get served too often. Selected WOM content is returned at step 512 (e.g., via a network to a client device 44 or other system). The steps of FIG. 7 can be repeated as needed or desired in various embodiments.

Turning now to FIG. 8, a flowchart of one embodiment of a method relating to dynamically inserting word-of-mouth content (e.g., into an advertisement or other media) is shown. As would be understood by one of skill in the art, all or a portion of each of the steps discussed relative to FIG. 8 may be executed by any capable system (e.g., WOM system 50 or another system).

Initially, at step 602 in one embodiment, a campaign can be defined. As part of defining the campaign, target user attributes, such as interests, age, gender, geography, profession, etc. may be defined in various embodiments, and a product associated with the campaign may be identified.

At step 604, in one embodiment, UGC associated with a product may be identified. This can be done, for example, based on mapping UGC to unique product identifiers. Additionally, the content can be filtered (e.g., identified) based on other criteria in the campaign definition.

At step 606, in one embodiment, a pool of identified WOM content (e.g., UGC associated with a product) and matching target user data is pre-selected for users matching various target user profiles. At step 608, in one embodiment, a request can be received for WOM content corresponding to a product (e.g., a request for UGC that is to be inserted into an advertisement or other media).

At step 610, in one embodiment, particular WOM content is chosen from pre-selected WOM content based on rules such as frequency rules or other rules so that, for example, the same piece(s) of WOM content do not get served too often. Selected WOM content is then returned at step 612, in one embodiment. The steps of FIG. 8 can be repeated as needed or desired.

Turning now to FIG. 9, a flowchart of one embodiment of a method relating to selecting and/or pre-selecting WOM content that matches target user data is shown. As would be understood by one of skill in the art, all or a portion of each of the steps discussed relative to FIG. 9 may be executed by any capable system (e.g., WOM system 50 or another system).

At step 654, contributor attributes are mapped to target attributes in one embodiment. The target attributes, in some embodiments, will map directly to contributor attributes collected by contributors of UGC. For example, gender, age, etc. may map easily (e.g., a relationship may be established between a contributor attribute and a target user attribute based on the respective attributes having obviously similar values, such as two ages or age ranges). In other cases, mappings may require selection of the particular contributor attributes to map to the target attributes (e.g., particular mappings may be specified).

Thus, in various embodiments, target attributes and contributor attributes can be mapped based on similarity between the two. For example, an advertiser may specify a target attribute value pair (for a campaign) is “Golfer Type: Expert”. However, contributor attributes may not have a Golfer attribute, but may instead have an attribute such as “Days Golfed a Month” (e.g., with potential values of 1-3, 4-5, 6-10, etc.). In this case, if the attribute “Days Golfed a Month” has a value of “6-10”, it may be mapped to “Golfer Type: Expert.” In another embodiment, “Days Golfed a Month:6-10” and “Days Golfed a Month:4-5” may both be mapped to “Golfer Type: Expert”. In another example in which a campaign is aimed at early adopters of a technology, contributor attribute “User Type:Tekkie” may be mapped to “User Type: Early Adopter” based on the knowledge that “Tekkies” may be likely to be similar to early adopters from the perspective of making electronics purchasing decisions. Mappings between target attributes and contributor attributes may be user defined or otherwise defined.

At step 656, in one embodiment, contributors of filtered WOM content can be matched to target user data based on a mapping. WOM content contributed by matching contributors (e.g., one or more best-matched contributors) may then be selected as a pool of WOM content matching a set of target user data in step 658, in one embodiment. In some embodiments, a single piece of WOM content (i.e., UGC) may be selected. The steps of FIG. 9 can be repeated as needed or desired.

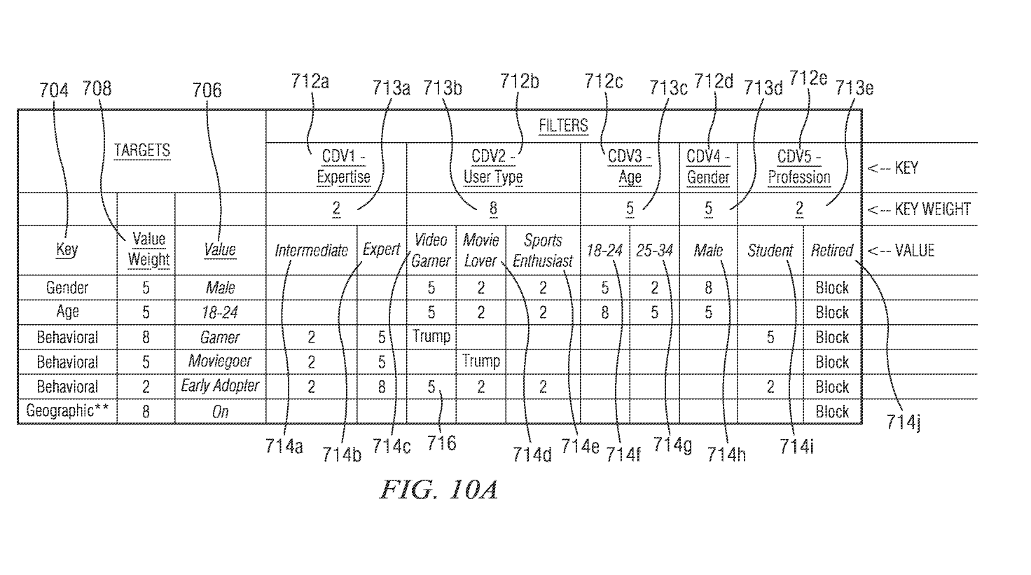

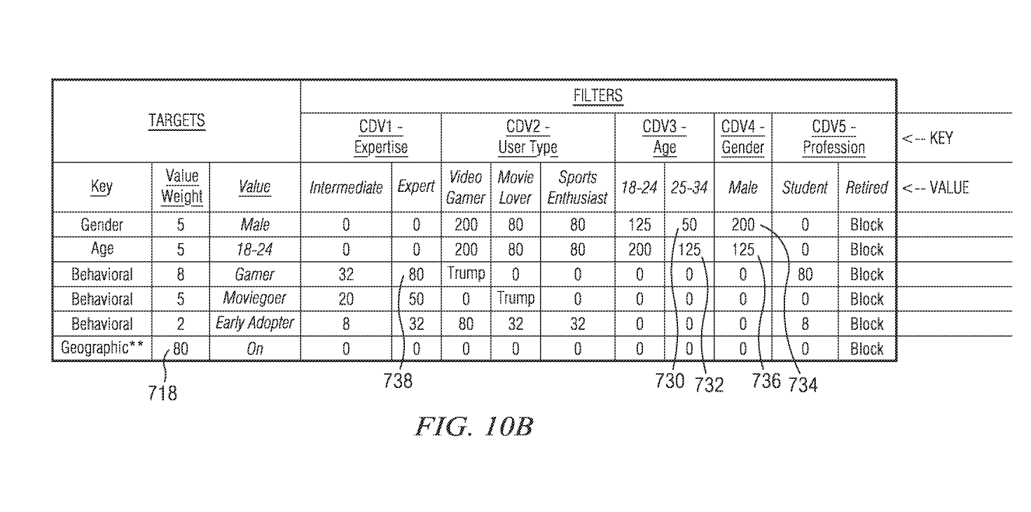

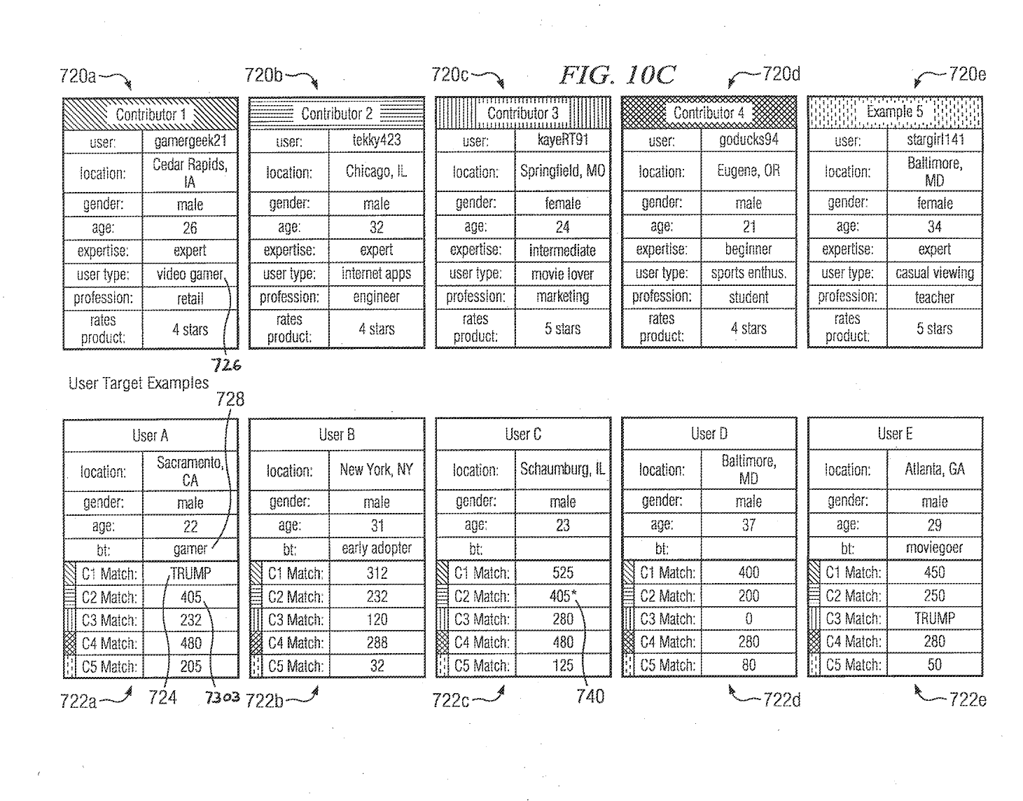

Turning now to FIG. 10A, a block diagram is presented that relates to one embodiment of mapping contributor attributes to target attributes for a campaign. Mapping, as described relative to the embodiment of FIG. 10A, may include specifying which contributor attribute values indicate what content by a contributor may be relevant to a target user having particular target attribute values.

As part of a campaign definition, target attributes for the campaign and attribute values of interest can be specified in various embodiments as key:value pairs (as shown, keys are represented at column 704 and values at column 706). In one embodiment, key:value pairs represent an audience a campaign is attempting to reach. In the embodiment of FIG. 10A, the campaign is attempting to reach males, people of 18-24 years of age, gamers, moviegoers, and early adopters, for example, as indicated by column 706. A geographic region attribute being listed as “On” furthermore indicates that location should also be a factor in targeting WOM content (while in other embodiments, location may not be factor in selecting WOM content).

In various embodiments, target attribute values may be given different weights such that, for example, key1:value1 may be assigned a different weight than key1:value2. In the embodiment shown, weights are 2, 5, or 8 (with 8 being most desirable). Accordingly, target attribute value weights 708 may reflect the perceived importance of each of the values 706, relative to each other. In this example, the status of a target user being a “gamer” therefore has more importance than the target user's gender in affecting the decision of what WOM content to provide. In other embodiments, attributes may be assigned an overall weight in addition to or in lieu of assigning weights to attribute values.

Contributor attributes can therefore be mapped to target attributes in one or more embodiments. The contributor attributes selected for mapping in a campaign may represent a selected subset of the universe of contributor attributes available for mapping, in some embodiments. According to one embodiment, for example, contextual data values from the contributor data are mapped to the target attributes. Such contextual data values are contributor attributes that review users have chosen to share with the ratings and review system through which they provided the reviews, in one embodiment.

In the embodiment of FIG. 10A, each contributor attribute is specified by a key:value pair. The keys are: Expertise (712a), User Type (712b), Age (712c), Gender (712d), and Profession (712e). Each attribute may have one more values in various embodiments (e.g., for each of the keys). In the example illustrated, Expertise 712a can include at least the values Intermediate 714a and Expert 714b; User Type 712b can include at least the values Video Gamer 714c, Movie Lover 714d, and Sports Enthusiast 714e; Age 712c can include at least the values 18-24 (714f) and 25-34 (714g); Gender 712d can include the values Male (714h) and Female; and Profession 712e can include at least the values Student (714i) and Retired (714j). Not every value for an attribute need be mapped, in various embodiments. For example, in the embodiment shown, Gender:Female is not included. Note, of course, that many other mappings are possible in different embodiments, and may include other attributes, possible values, etc.

In various embodiments, each contributor attribute 712a-712e selected for mapping may be assigned an overall attribute weight 713a-e (referred to in FIG. 10A as a “key weight” because each contributor key:value pair with the same key is assigned the same weight). Thus, in the example illustrated, key weights 213a-e are one of three values: 2, 5, or 8. These values reflect the relative importance of the attributes with respect to one another in matching contributors to the campaign overall, in one embodiment. Thus, for example, User Type 712b is assigned a value of 8 while Expertise 712a is assigned a 2, meaning that the User Type attribute is given four times more relevance (weight) in determining matching UGC (for example, because “User Type” may be believed to be a better predictor of the relevance of material provided by a contributor than a contributor's “Expertise” level). Accordingly, as shown in the embodiment of FIG. 10A, “Expertise” and “Profession” are given equal weight relative to each other as categories, although as explained further below, values within those categories may have their own contributor attribute value weights.

Accordingly, in the embodiment shown, each of contributor values 714a-j may be assigned a contributor attribute value weight (e.g., relative to target attribute values). The values 714a-j may take on individual weightings depending on how well they match (or are believed to match) target values 704. In some embodiments, contributor attribute values are only assigned weights relative to some target attribute values. For example, in the embodiment of FIG. 10A, Gender:Male is only assigned contributor attribute value weights relative to the target attribute values Gender:Male and Age:18-24.

In the example illustrated, possible different value weights assigned to contributor attribute values are 2, 5, 8, “Block,” and “Trump,” as well as no value relative to the target attribute values (e.g., a value such as 0 that indicates no weighting is being given). The value “Trump” indicates that a match is believed to be highly predictive of relevance, whereas the value “Block” indicates the opposite. For example, the attribute value User Type:Video Gamer is assigned a value of Trump relative to the target attribute value Behavioral:Gamer in the embodiment of FIG. 10A, which indicates that content by a contributor associated with User Type:Video Gamer is likely to be highly relevant to a target user associated with the target attribute Behavioral:Gamer. Conversely, content by a contributor associated with the contributor attribute Profession:Retired may be highly unlikely to be relevant to a target user associated with the target attribute Behavioral:Gamer.

In the embodiment of FIG. 10A, the value 714b of “Expert” for the contributor attribute “Expertise” is given a weight of 5 relative to the target attribute value “Moviegoer.” In contrast, the value 714b of “Expert” for the contributor attribute “Expertise” is given a weight of 8 relative to the target attribute value “Early Adopter.” This indicates that content by a contributor associated with the attribute Expertise:Expert will be considered as being (relatively) more relevant to a target user associated with the attribute Behavioral:Early Adopter than a target user associated with the attribute Behavioral:Moviegoer. Stated another way, for content-matching purposes, it may be considered more relevant for a person to be an “Expert” in some categories than others, in some embodiments.

In the embodiment of FIG. 10A, contributor attributes are weighted relative to each other at the “key” level (712a-712e), while targeted attributes are mapped relative to each other at the value level. However, in other embodiments, contributor attributes could be mapped at the value level and target attributes at the key level. Thus, different weighting schemes for mappings are contemplated in various embodiments.

According to one embodiment, weighted values can be used to determine an attribute value match score of contributor attribute value/target attribute value pairs for the campaign. For example, as discussed further herein, the match score between a contributor attribute value and a target attribute value can be determined by multiplying the overall contributor attribute weight for the contributor attribute by the weight for the contributor attribute value relative to that target attribute value by the value weight 708 for the target attribute value.

Thus, using an example of calculating an attribute value match score for the contributor attribute value User Type:Video Gamer to the target attribute value Behavioral:Early Adopter, the overall contributor attribute weight 713b is multiplied by the target attribute weight 708 for the target attribute value Early Adopter, by the contributor attribute value weight for User Type:Video Gamer relative to Behavioral:Early Adopter, (indicated at 716) resulting in a match score of 80 (8*2*5) for the User Type:Video Garner/Behavioral:Early Adopter attribute value pair. This example match score of 80 may also be seen in FIG. 10B.

Thus, turning now to FIG. 10B, a diagram illustrating a table in which attribute value match scores have been calculated for each target attribute value/contributor attribute value pair (e.g., in the manner discussed above) is shown. FIG. 10B illustrates that a “TRUMP” weight results in a “TRUMP” match score and a “BLOCKED” weight results in a “BLOCKED” match score, in various embodiments. FIG. 10B further illustrates that a default match score can be used for certain attributes. For example, a geographic match has a default match score 80 (indicated at 718). These attribute value match scores can be used to calculate a contributor-to-target match score, which provides a measure of how well a contributor matches a set of target user data in one embodiment.

Turning for the moment to FIG. 10C (for example, to provide some context for calculating contributor-to-target match scores), a diagram is shown illustrating example contributors (720a, 720b, 720c, 720d, 720e) and example end users (722a, 722b, 722c, 722d, 722e). In the embodiment shown, contributor information can be parameterized according to defined contributor attributes and target user information can be parameterized according to target attributes. Thus, for example, Contributor 1 (720a) can be associated with contributor attribute value Age:25-34, in one embodiment. Similarly, User A can be associated with the target attribute value Behavioral:Gamer, in one embodiment.

The contributor-to-target match score for each example contributor/target user pair is shown is FIG. 10C. For example, as indicated at 724, the contributor-to-target match score between Contributor 1 (720a) and User A (722a) is “TRUMP”. This is because Contributor 1 is associated with the contributor attribute value “User Type:Video Gamer” (as indicated at 726) and User A is associated with the target attribute value “BT:Gamer” (as indicated at 728). As shown in FIG. 10B, the intersection of “User Type:Video Gamer” and “Behavioral:Gamer” is “TRUMP,” which' indicates that content contributed by Contributor 1 for a product at issue in the campaign is believed to be more likely to be relevant to User A than content provided by the other contributors (who have numeric scores corresponding to values less than “TRUMP”, as seen in FIG. 10C). Also note that in accordance with frequency rules discussed herein relative to various embodiments, however, the fact that a given contributor has a “TRUMP” value for a given user does not indicate that the given user will invariably see content from the given contributor, for example.

Although not shown, in various embodiments, if a “BLOCK,” occurs, then content from a contributor will not be provided to the user. If both a “BLOCK” and a “TRUMP” occur for a contributor/target user pair, rules can be applied as to whether the “TRUMP” or “BLOCK” has priority (e.g., using frequency rules or other rules).

In cases in which there is not a “TRUMP” or a “BLOCK,” a contributor-to-target match score can be calculated, in some embodiments, by adding the attribute value match score for each contributor attribute value/target attribute value pair shared by the contributor/target user pair. If a contributor attribute value is a member of multiple contributor attribute value/target attribute value pairs for the contributor/target user pair, only the highest match score for that contributor attribute value is counted in some embodiments. Similarly, if a target attribute value is a member of multiple contributor attribute value/target attribute value pairs for the contributor/target user pair, only the highest match score for the target attribute value is counted in various embodiments.

To provide an example, in one embodiment, the contributor-to-target match score for Contributor 2 to User A is 405, as indicated at 7303. Contributor 2 is associated with particular contributor data (“location:Chicago, Ill.”, “Gender:Male”, “Age:32”, “Expertise:Expert”, “User Type:Internet Apps”, “Profession:Engineer”). User A is associated with particular target user information (“location:Sacramento, Calif.”, “Gender:Male”, “Age:22”, “BT:Gamer”) (where “BT” may indicate a behavioral type). Thus, with reference to the embodiment of FIG. 10B, the Contributor 2/User A pair have the following mapped contributor attribute value/target attribute value pairs: Age:25-34/Gender:Male (indicated at 730), Age:25-34/Age:18-24 (indicated at 732), Gender:Male/Gender:Male (indicated at 734), Gender:Male/Age: 18-24 (indicated at 736), Expertise:Expert/Behavioral:Gamer (indicated at 738).

In this example, the contributor attribute value “Age:25-34” is associated with two attribute value match scores, respectively indicated at 730 and 732 in FIG. 10B. Similarly, the contributor attribute value “Gender:Male” is associated with two attribute value match scores, respectively indicated at 734 and 736. For each such contributor attribute value in one or more embodiments, only the highest associated match score is counted. Accordingly, in one embodiment, because score 732 is greater than score 730 for the “Age:25-34” contribute attribute value, score 732 is used and score 730 is ignored. Therefore, in one embodiment, the contributors-to-target match score for the Contributor 2/User A pairing can be calculated by adding the match scores indicated at 734, 732 and 738, resulting in a score of 405 (as indicated at 7303 of FIG. 10C). Match scores can be similarly calculated for each contributor/target user pair in various embodiments.

In reviewing FIGS. 10C and 10B, it can be further seen that geographic proximity can increase a contributor-to-target match score in some embodiments. For example, because Schaumberg, Ill. may be considered as being in the same market area as Chicago, Ill., in one embodiment, a geographical match exists between User C and Contributor 2, contributing 80 points to the contributor-to-target match score indicated at 740.

In one embodiment, contributor-to-target match scores can be used to select a pool of WOM content (e.g., pool 89) that matches target information. In various embodiments, content associated with a contributor having a higher contributor-to-target match score may therefore have a higher score (e.g., indicating higher potential advertising value) than content associated with a contributor having a lower contributor-to-target store. In some embodiments, only content having a score above a threshold score (or above some rank, e.g., the top 30 pieces of best-matching content, the top 10% of filtered content, etc.) is selected for a pool of content that matches target user data. In one embodiment, a WOM content pool may contain at least 30 pieces of content, though less or more can be included in various embodiments.

In one embodiment, once a pool is established for a particular combination of target user data, the pool may be maintained such that subsequent requests corresponding to users having the same combination of target user data are responded to from the same pool. The pool can be re-determined periodically to account for the fact that new WOM content may have been added to the filtered WOM content, in various embodiments.

In one embodiment, WOM content in a pool (e.g., pool 89) can be served (e.g., selected) based on one or more rules. As one example, a rule may specify that WOM content should be served based on relative rankings such that content with a higher score (e.g., higher-valued content) is served more often and content with a lower score served less often. Accordingly, in some embodiments, the relative scores of content may determine the frequency with which that content is selected (for example, first UGC with a score of “1000” may be selected twice as frequently from a content pool, on average, as second UGC with a score of only “500”). As another example, a rule may specify that a piece of WOM content can only be served once every 30 seconds or only once every 30 seconds to users meeting a particular profile (though one of skill in the art will realize that time periods of greater or lesser length may be used). Rules governing the serving of WOM content can be arbitrarily complex in various embodiments, as would occur to one with skill in the art.

With reference to the embodiments of FIGS. 10A-10C, there are only a limited number of target user profiles to which a campaign will apply. Therefore, contributor-to-target match scores can be calculated for each contributor who contributed filtered WOM content and each potential set of target attribute values for the campaign (or some subset of the potential sets of target attribute values), in these embodiments. Relative to the example campaign of FIG. 10A, match scores can be calculated for Contributors 1-5 and target user profiles having any combination of one or more of: “Gender:Male,” “Age:18-24,” “Behavioral:Gamer,” “Behavioral:Moviegoer,” “Behavioral:Early Adopter.” Separate scores can be calculated for cases in which there is a geographical match and not a geographical match. As such, one of skill in the art would understand that one or more match scores (or portions thereof) may be pre-computed, in some embodiments.

In one embodiment, a first target user profile can be defined with the following target attribute values: “Gender:Male”, “Age:18-24”, “Behavioral:Gamer” (with such a profile being labeled as “Profile 1”). Match scores without geographical match can be calculated (e.g., pre-computed) and would be identical to those shown for User A in FIG. 10C, in this example. Accordingly, when a request is received corresponding to a user matching Profile 1, such as user A, a WOM system (e.g., system 50) need only determine if there is a geographic match between User A and each contributor to determine the best match contributors, which may save processing time.

Thus, in this example, without consideration to geographical matching (or other factors), final match scores for Contributors 1-5 and Profile 1 would be known for any user meeting Profile 1. Consequently, the best match contributors for Profile 1 can be determined (and in this example, Contributors 1 and 4 are the best-matched contributors for Profile 1). Therefore, WOM content associated with (e.g., contributed by) Contributors 1 and 4 can be selected as matching content for Profile 1, which may create a pool with two pieces of WOM content, in various embodiments. When a request corresponding to User A is received in these embodiments, one or more pieces of this pre-selected content can therefore be provided in response because user A fits target Profile 1. (Further, as Contributor 1 has a higher score than contributor 4, content submitted by Contributor 4 can be provided more often to users matching Profile 1 than content contributed by contributor 4 in some embodiments, such as embodiments in which frequency rules are used to determine relative frequency for serving (selecting) UGC). In some embodiments, ads including matching (selected) WOM content can be cached for serving to users associated with particular sets of target user data.

The contributor-to-target match scores may provide a measure of how well contributors match target user data and, hence, may indicate how well content submitted by those contributors matches target user data, in various embodiments. Contributor-to-target match scores may be determined in other manners that provide a measure of how well contributors match target user data, in other embodiments.

Any number of contributor attribute values can be mapped to any number of target attribute values such that the mappings can be arbitrarily complex in various embodiments. According to one embodiment, a user can be provided with a user interface that allows the user to define mappings between contributor attributes and target attributes, and corresponding weights. In other embodiments, mappings and weights can be defined programmatically (e.g., predefined).

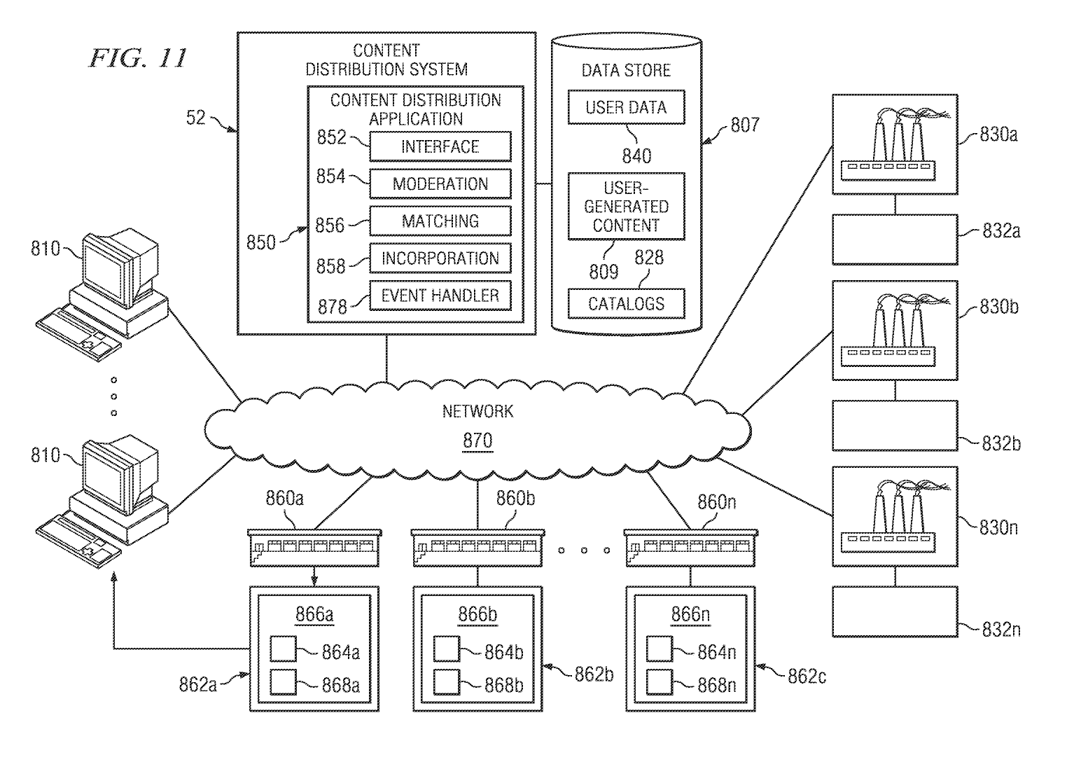

Turning now to FIG. 11, a diagram is shown of one embodiment of a content collection topology including a content system 52. In various embodiments, content system 52 may be a content collection system, and in some embodiments, may also be configured to distribute content (i.e., be a content distribution system, such as labeled in FIG. 11). As noted above, in some embodiments, one or more aspects of content system 52 may be integrated with WOM system 50, and vice versa. Furthermore, the embodiment of FIG. 11 relates to merely one example of how UGC may be collected and/or distributed; this disclosure is not limited to this example, and other topologies and/or system architectures are contemplated, as will be appreciated by those with skill in the art.

In the embodiment of FIG. 11, manufacturers 830 (i.e., manufacturers 830a, 830b, 830n, etc.) may produce, wholesale, distribute or otherwise be affiliated with the manufacture or distribution of one or more products. Retailers 860 (i.e., retailers 860a, 860b, 860n, etc.) may be sales outlets for products made by one or more of manufacturers 830a-n. In fact, in some embodiments, each retailer 860a-n will sell products from multiple manufacturers 830. These products may be provided for sale in conjunction with one or more web sites (referred to also as sites) 862a-n (i.e., 862a, 862b, 862c, etc.) (or brick and mortar stores) provided by each of retailers 860 such that users at computing devices 810 may access a web site system (e.g. one or more computing device, which may for example, include one or more web servers) providing the retailer's site 862 over network 870 (for example. the Internet or another type of communications network) in order to purchase these products or perform other actions.

In addition to offering the ability to purchase these products, retailer's site 862 may offer the ability for a user to access UGC associated with certain subjects such as products (e.g., goods, services, categories of goods or services, brands, etc.) offered for sale on or otherwise related to a retailer's site 862. By accessing such UGC at the retailer's site 862 a user may be better able to make a purchasing decision with respect to the various products offered for sale on that retailer's site 862 or may be more inclined to buy a product, as the user feels that the product has received positive UGC (reviews, ratings, questions/answers, etc.) from a critical mass of other users, etc., in various embodiments. A user may thus purchase a manufacturer's product from a retailer 860 using retailer's site 862.

Retailer site 862 may also offer the ability for a user to generate content with respect to products offered for sale by retailer 860 (or other products), though UGC may also be generated via sites other than site(s) 862 in various embodiments. In other words, a user may utilize the retailer's site 862 to generate user reviews, ratings, comments, problems, issues, question/answers, or almost any other type of content regarding a product or experience with the product, brand, manufacturer or retailer, and this UGC may be displayed to other users accessing retailer's site 862 in some embodiments. It will be apparent, however, that there may be many other ways to purchase or obtain such a product and/or to generate UGC for a product.

To allow people to provide UGC with respect to a particular product, manufacturer's site 832, retailer's site 862, other site, etc., can provide the ability for a user to generate content with respect to various products. In other words, a user may use the manufacturer's site 832, retailer's site 862, or other means, to generate user reviews, ratings, comments, problems, issues, question/answers, or almost any other type of content (e.g., UGC) regarding a product (e.g., brand or manufacturer, usually regardless of where the user purchased the manufacturer's product.

In one embodiment, UGC which may be generated at a retailer's site 862 manufacturer's site 832, etc., may include reviews, stories, question/answer content or any other type of content in any format which the user wishes to add regarding a product. Reviews may correspond but are not limited to a user evaluation of a product and include ratings of product (for example, a number of stars or numerical rating), pros and cons of the product, a descriptive title and a description of a user's experience with a product (referred to as the body of the review), attributes of the user generating the review (for example, demographic information), other product(s) which compliment or may be used with the product being reviewed, pros and cons of the product or any other type of evaluation of a product or aspects of a user's experience with the product. Ask/Answer content may comprise questions or answers submitted by a user, retailer or manufacturer concerning a potential purchase decision, for example regarding the capabilities or use of a product or category of products, demographic information on a user generating a question or answer. UGC may include stories that pertain to open ended experiences with one or more products or categories of products which may be more tangentially related to the product than, for example, reviews, in some embodiments.

Content system 52 may be coupled to network 870 in various embodiments and serve to collect and/or distribute content generated at retailer's site 832, manufacturer's site 862, or another location, and distribute the content to retailers' sites 862 or another location. Content system 52 allows content to be distributed to many retailers 860 or other destinations in various embodiments.

Furthermore, in some embodiments, centralized distribution of UGC may have a number of business advantages. For example, as the sale of products is important to manufacturers 830, these manufacturers 830 may pay operators of content system 52 for formatting or distributing content to the retailer's sites 862. This may be in contrast to payment flows in some embodiments in which a retailer 860 gets paid for displaying advertising, or content aggregators are paid by portals who display the data and who in turn charge manufacturers 830 for lead generation. Similarly, since incorporation of UGC may also drive off-line purchases (after reading reviews at a site 862 a potential purchaser may drive to a physical store to make a purchase of that good) payment may be made by a manufacturer 830 or retailer 860 irrespective of where the product was purchased (for example, on-line versus off-line purchases), in one or more embodiments.

Thus, in some embodiments, the content from content system 52 may be incorporated into an area of a web page of retailer's site 862 using a <div> tag (or another type of HTML element or tag (e.g. an <iframe>), or another type of mechanism) which works in conjunction with a software application associated with content system 52 (such as JavaScript or other set of computer readable instructions) included on the web page or at the computing devices providing retailer's site 862 that is used to make calls back to the content system 52 to incorporate the desired content for that page.

In certain embodiments, when a web page of retailer's site 862 (or another site) is loaded on a browser at a user's computer 810 the web page includes a script or other mechanism (e.g. JavaScript or asynchronous JavaScript and XML (AJAX), JavaScript Object Notation (JSON), ActiveX, etc.) by which a request for UGC for the web page is made to the content system 52. In response to the request, the content system 52 may return appropriate content (including UGC) to the user's computer 810 for incorporation into the rendered web page, which may be incorporated as part of an advertisement, social media page, etc., in various embodiments.

Content system 52 may include one or more computers communicatively coupled to a network 870 and a data store 807 in various embodiments. Data store 807 may comprise UGC 809, catalogs 828 and user data 840 in one embodiment. UGC 809 may be associated with one or more products or categories, where this UGC may have been generated at manufacturer's site 832, retailer's site 862 or at another location altogether, in some embodiments. Catalogs 828 may comprise a set of catalogs, each catalog corresponding to a retailer 860 or manufacturer 830. User data 840 may comprise any user attributes for user who submit UGC including for example, user identifiers, email addresses or other user information, in various embodiments.

Content system 52 may also include, in one embodiment, a content collection application 850 which comprises interface module 852, moderation module 854, a matching module 856 an event handler module 878 and an incorporation module 858. Moderation module 854 may moderate (for example, filter or otherwise select), or allow to be moderated, content which is, or is not to be, excluded or included, while matching module 856 may serve to match received UGC with a particular product or category. In one embodiment, this matching process may be accomplished using catalogs 828.

In one embodiment, incorporation module 858 may be configured to incorporate a tool for the generation of content into a manufacturer's portal, or a retailer's or manufacturer's site. Furthermore, incorporation module 858 may be used to incorporate UGC into a retailer's site 862, or other site, for display to a user, in various embodiments. In particular, a user may generate content regarding a product or category at manufacturer's site 832 or retailer's site 862 (or another site) using a content generation tool (for example, a GUI, webpage, widget, etc.) presented on the site. This tool may be implemented or developed by operators of content system 52 and provided for use with the site to facilitate the generation of content by users, or the subsequent processing, distribution and incorporation of such content by content system 52. These tools may be hosted by incorporation module 858 of content system 52. Thus, for example, on a page of retailer's site 862 a content generation tool may be included, such that the tool hosted at content system 52 may be incorporated in the site 862 for use by a user at the site 862, in one embodiment.

In any event, the content generated by the user with respect to a may be received by content system 52 and stored as UGC 809 in association with one or more identifiers. One identifier, in one embodiment, may be a unique identifier assigned by content system 52 such that each piece of received UGC may be uniquely identified. Another identifier may be timestamp indicating the time at which such content was received at the content system 52. Still another identifier that may be associated with received UGC is a site of origin. This site of origin may identify the web site at which the UGC was generated or the web site from which the UGC was received. This site of origin may, for example, be a domain, subdomain or localization of a domain (e.g. orbitz.com may be considered a different site of origin than oribitz.co.uk or orbits.es).

Other identifiers may be utilized in various embodiments to associate content with one or more web pages (which may, for example, be associated with a product) or another entity such as a section of a web site, multiple web sites, a product, a category, a brand, etc. Such an identifier may serve to group a set of content (which may have been generated at multiple retailer's or manufacturer's web sites or other sites) together so that it may be displayed in one location (for example, on a product page, a category page, or particular section of a site, etc.), in some embodiments. Accordingly, an identifier may, in some embodiments, represent an actual product in the traditional sense of the word, a category comprising a collection of products (e.g., as related to a brand), or simply a particular container, page, or section of a site, including the entire site, itself or multiple web sites, and serve to group a set of content.

Received content may be moderated by moderation module 854, to determine if such content should be utilized for display on a site, edited for suitability, etc., in various embodiments. This moderation process may comprise different levels of moderation in some embodiments. In one embodiment, moderation may comprise associating identifiers with received UGC. These identifiers may associate UGC with a manufacturer, products, brand or categories of products offered for sale by retailer 860 or the manufacturer 830, user attributes of the user who generated the content, product attributes, etc. Thus, for example, received UGC may be associated with a product identifier associated with a particular product or a category identifier associated with a particular category and a user that submitted the UGC and the content and the associated identifiers stored in data store 807.

At least a portion of such associations may be determined using matching module 856 which may compare data received in conjunction with UGC (for example, product data, category data, user data, etc.) with data in a catalog 828. Once it is decided that the UGC is to be stored in data store 807 and allowed to be disseminated (for example, has been moderated), event handler 878 may take certain actions based on the UGC or its associated data, such as emailing a user, sending alerts to a manufacturer that new content regarding one of its products has been received, etc., in various embodiments.

Accordingly, a user browsing, for example, retailer's site 862 (or another site) may access a web page or other portion of a site corresponding to a particular product or category. UGC 868a-n (i.e., UGC 868a, 868b, 868n, etc.) associated with that product or category may be displayed on a user's browser such that a user viewing a portion of the retailer's site associated with a particular product or category may have UGC 868 associated with that product or category displayed to him. This UGC, may, for example, have been originally generated at the retailer's site 862, through the manufacturer's site 832 or at another site, in some embodiments. Thus, the display of this UGC to the user while he is shopping, may, in turn, motivate the user to make a purchase through retailer's site 862 or another site (e.g., on which an advertisement incorporating UGC is displayed).

In one embodiment, both the UGC displayed on the web page and a content generation tool for the generation of new content may be provided in conjunction with one another. Specifically, in one embodiment, the content from content system 52 or a content generation tool may be incorporated into a portion of the web page of retailer's site 862 using an element such as an iframe or div tag, another type of HTML element or tag, or another type of mechanism altogether, and may be accessed through a variety of elements, such as a tab or link displayed on the web site or tile like.

In one embodiment, an inclusion module (e.g., 864a, 864b, 864n, etc. (such as JavaScript or other type of computer instructions)) may be included at the retailer's site 862 or associated with a particular web page of the retailer's site. Thus, in one embodiment, content distributor inclusion module 864 works in conjunction with incorporation module 858 of content system 52 by making calls back to the incorporation module 858 on content system 52 to incorporate the desired content for that page along with a content generation tool.

In one embodiment, when a web page (e.g., one of 866a-n) a from retailer's site is loaded at a user computer 810 the HTML for the page may load, including the element used to incorporate content from the content provider system 52. In one embodiment, a content distributor software module 864 (which may have been provided by operators of the content system 52 or implemented by operators of the retailer's site 862) may also load at this time to access incorporation module 858 to obtain UGC (e.g. reviews, stories, etc., as discussed above) for inclusion in the web page 866 (or other content or media) in conjunction with the element such that the obtained UGC can be displayed in the web page 866 of the retailer's site.

In one embodiment, content distributor software module 864 is associated with content system 52, and resident on retailer's site 862, may be executed when the web page 866 is loaded. This content distributor software module 864 may send data associated with the web page 866 such as the product data, user data, display codes, etc., in some embodiments, to incorporation module 858. Incorporation module 858 may utilize this data, in one embodiment, to determine a set of UGC 868 from the stored UGC 809 to return, format this UGC 868 accordingly and return this UGC to the calling content distributor software module 864.

Accordingly, in one embodiment, content distributor software module 864 executing on the browser at the user's computer 210 receives content from the incorporation module 858 and incorporates the content into the element on the web page 866 configured to display the content. Calling content system 52 to obtain UGC 868 for display in a web page when that web page is rendered by the browser at the user's computer 810 may allow content retrieved from the content system 52 by the content distributor software module 864 to be fresh, in various embodiments. (In other words, content recently received by the content system 52 may be included on a web page 866 without alteration to the web page 866, in one embodiment, and the format or appearance of such UGC may be altered without alteration to the code that comprises the web page itself.)

Content system 52 may also include modules to collect additional information such as web analytics as described, for example, in U.S. patent application Ser. No. 12/888,559, entitled “Method and System for Collecting Data on Web Sites,” filed Sep. 23, 2010, which is hereby fully incorporated by reference.

The content system of FIG. 11 is provided by way of example and UGC and related information may be distributed and collected in any suitable manner. For example, a retailer's web site may provide UGC and content generation tools such that requests for UGC and content distribution tools are made to the retailer's web site. Similarly, a retailer's site can receive new UGC, and accordingly, the retailer may maintain the data store of UGC and incorporate UGC and content generation tools into web pages in various embodiments. Thus, the segregation of content system 52 from a retailer's site, as discussed above, is only one embodiment and the same entity may provide content distribution and the retailer site in various embodiments.

In another embodiment, a retailer (or other entity) may relay requests for UGC and content generation tools to a third-party provider and submit new UGC to the third party provider. The third party provider may provide appropriate information in response to a retailer for inclusion into the retailer's web site. Thus, a third-party provider may provide a content system, while a client web browser interacts with retailer's web site but not directly with the third party, in one embodiment. In yet another embodiment, one entity, such as a retailer, may be responsible for incorporating UGC and content generation tools into web pages, while another entity receives submissions of new UGC.

With reference to FIGS. 2 and 11, WOM content 68 may be all or a subset of UGC 809, in some embodiments. For a particular campaign, particular UGC may be eliminated for inclusion in filtered WOM 87 for any number of reasons. For example, an advertiser may not have rights to distribute content collected from specific sites. As another example, particular pieces of UGC may not fit the goals of an advertising campaign and can be eliminated if desired, in various embodiments. In any case, collection system 52 is provided by way of example and WOM 68 may include UGC collected by any number of other content systems.

Furthermore, while WOM content distribution has been discussed herein in terms of dynamically injecting word-of-mouth content into advertisements, other embodiments of word-of-mouth content distribution systems can be configured to provide word-of-mouth content for inclusion in web pages in non-advertisement portions of a web page or other media, in various embodiments. According to one embodiment, selecting WOM content can be used to select which reviews to surface first to a user in a ratings and reviews system, for example. In addition, WOM systems may distribute WOM content to other channels, such as through email, connected television or other systems that can ingest the WOM content, in some embodiments.

Embodiments described herein can be implemented in a computer communicatively coupled to a network (for example, the Internet), another computer, or in a standalone computer, in various embodiments. Turning now to FIG. 12, one embodiment of a computer 900 is shown. Computer 900 may comprise a central processing unit (“CPU”) 922, read-only memory (“ROM”) 924, random access memory (“RAM”) 926, hard disk drive (“HD”) or storage memory 928, and input/output device(s) (“I/O”) 929. I/O 929 may include a keyboard, monitor, printer, electronic pointing device (e.g., mouse, trackball, stylus, etc.), or other suitable components. Computer 900 may have access to at least one database over a network. Computer 900 may have more than one CPU, ROM, RAM, HD, I/O, or other hardware component in various embodiments, and many possible hardware configurations are possible.

ROM, RAM, and HD are computer memories for storing computer-executable instructions executable by the CPU or capable of being complied or interpreted to be executable by the CPU. Within this disclosure, the term “computer readable medium” or is not limited to ROM, RAM, and HD and can include any type of data storage medium that can be read by a processor. For example, a computer-readable medium may refer to a data cartridge, a data backup magnetic tape, a floppy diskette, a flash memory drive, an optical data storage drive, a CD-ROM, ROM, RAM, HD, or the like. The processes described herein may be implemented in suitable computer-executable instructions that may reside on a computer readable medium (for example, a disk, CDROM, a memory, etc.). Computer-executable instructions may be stored as software code components on a DASD array, magnetic tape, floppy diskette, optical storage device, or other appropriate computer-readable medium or storage device, in various embodiments. In various embodiments, computer-executable instructions may comprise C++, Java, JavaScript, HTML, or any other programming or scripting code. Various software/hardware/network architectures may be used. For example, functions described with respect to various embodiments may be implemented on one computer or shared among two or more computers. Accordingly, functions of disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols, in various embodiments.

Thus, above-described techniques and methods may be implemented as computer-readable instructions stored on any suitable computer-readable storage medium. As used herein, the term computer-readable storage medium refers to a (non-transitory, tangible) medium that is readable by a computing device or computer system, and includes magnetic, optical, and solid-state storage media such as hard drives, optical disks, DVDs, volatile or nonvolatile RAM devices, holographic storage, programmable memory, etc. The term “non-transitory” as applied to computer-readable media herein is only intended to exclude from claim scope any subject matter that is deemed to be ineligible under 35 U.S.C. §101, such as transitory (intangible) media (e.g., carrier waves per se), and is not intended to exclude any subject matter otherwise considered to be statutory. Computer-readable storage mediums can be used, in various embodiments, to store executable instructions and/or data. In some embodiments, particular functionality may be implemented by one or more software “modules”. A software module may include one or more executable files, web applications, and/or other files, and in some embodiments, and may make use of PHP, JAVASCIPT, HTML, Objective-C, JAVA, or any other suitable technology.

### LISTING OF SELECTED EMBODIMENTS

### Embodiment 1

A method, comprising:

receiving, at a computer system, a request for user-generated content (UGC) to be provided as an advertisement to a target user, wherein the target user is associated with a set of one or more target user attributes;

in response to receiving the request, the computer system determining a selected item of UGC from a plurality of items of UGC, wherein the determining the selected item of UGC is based on:
one or more of the set of target user attributes; and
one or more of a set of one or more contributor attributes, wherein the set of contributor attributes corresponds to one or more characteristics of a contributor of the selected item of UGC; and

the computer system causing at least a portion of the selected item of UGC to be transmitted via a network.

### Embodiment 2

The method of embodiment 1, wherein the determining the selected item of UGC is based on a plurality of the set of contributor attributes.

### Embodiment 3

The method of embodiment 1, wherein the determining the selected item of UGC includes calculating a measure of a match of the contributor of the selected item of UGC to the one or more of the set of target user attributes.

### Embodiment 4

The method of embodiment 3, wherein the match of the contributor is based on at least one of the set of target user attributes having a different value from a value for a corresponding one of the set of contributor attributes.

### Embodiment 5

The method of embodiment 1, wherein the determining the selected item of UGC comprises matching values for individual ones of the set of target user attributes to values for individual ones of the set of contributor attributes.

### Embodiment 6

The method of embodiment 5, wherein the matching includes using at least two different weighting values for two or more of the set of target user attributes.

### Embodiment 7

The method of embodiment 5, wherein the matching includes using at least two different weighting values for two or more of the set of contributor attributes.

### Embodiment 8

The method of embodiment 1, wherein the contributor of the selected item of UGC is an author of text comprising the at least a portion of the selected item of UGC.

### Embodiment 9

The method of embodiment 1, wherein the determining the selected item of UGC is based on a plurality of the set of target user attributes.

### Embodiment 10

The method of embodiment 1, wherein the causing the at least a portion of the selected item of UGC to be transmitted includes causing the at least a portion of the selected item of UGC to be included as part of an advertisement.

### Embodiment 11

A computer-readable storage medium having stored thereon instructions that are executable by a computer system to cause the computer system to perform operations comprising:

receiving a request for user-generated content (UGC) to be provided as web content to a target user, wherein the target user is associated with a set of one or more target user attributes;

in response to receiving the request, determining a selected item of UGC from a plurality of items of UGC, wherein the determining the selected item of UGC is based on:
one or more of the set of target user attributes; and
one or more of a set of one or more contributor attributes, wherein the set of contributor attributes corresponds to one or more characteristics of a contributor of the selected item of UGC; and

causing at least a portion of the selected item of UGC to be transmitted via a network.

### Embodiment 12

The computer-readable storage medium of embodiment 11, wherein the web content includes an advertisement, and wherein the operations further comprise causing the at least a portion of the selected item of UGC to be inserted into the advertisement.

### Embodiment 13

The computer-readable storage medium of embodiment 11, wherein the web content includes at least a portion of a social media page, and wherein the operations further comprise causing the at least a portion of the selected item of UGC to be inserted into the at least a portion of the social media page.

### Embodiment 14

The computer-readable storage medium of embodiment 11, wherein the determining the selected item of UGC includes calculating a measure of a match of the contributor of the selected item of UGC to the one or more of the set of target user attributes.

### Embodiment 15

The computer-readable storage medium of embodiment 14, wherein calculating the measure of the match is based on a level of expertise indicated by a value for a first one of the set of contributor attributes.

### Embodiment 16

The computer-readable storage medium of embodiment 11, wherein the determining the selected item of UGC comprises matching values for individual ones of the set of target user attributes to values for individual ones of the set of contributor attributes, and wherein the matching includes using at least two different weighting values for two or more of the set of target user attributes.

### Embodiment 17

A computer system, comprising:

a processor;

a network interface configured to couple to a network; and

a computer-readable storage medium having stored thereon instructions that are executable by the computer system, using the processor, to cause the computer system to perform operations comprising:
receiving a request for user-generated content (UGC) to be provided as an advertisement as a portion of a web page transmitted to a target user, wherein the target user is associated with a set of one or more target user attributes;
in response to receiving the request, determining a selected item of UGC from a plurality of items of UGC, wherein the determining the selected item of UGC is based on:
   one or more of the set of target user attributes; and
   one or more of a set of one or more contributor attributes, wherein the set of contributor attributes corresponds to one or more characteristics of a contributor of the selected item of UGC; and
causing at least a portion of the selected item of UGC to be transmitted via the network.

### Embodiment 18

The computer system of embodiment 16, wherein the plurality of items of UGC are pre-selected based on one or more specified criteria from another set of items of UGC.

### Embodiment 19

The computer system of embodiment 16, wherein the determining the selected item of UGC comprises matching values for individual ones of the set of target user attributes to values for individual ones of the set of contributor attributes, wherein the matching includes using at least two different weighting values for two or more of the set of contributor attributes.

### Embodiment 20

The computer system of embodiment 16, wherein the advertisement is for a particular good or service.

Although specific embodiments have been described herein, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art. The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method, comprising:
receiving, at a computer system, a request for user-generated content (UGC) to be provided as an advertisement to a target user, wherein the target user is associated with a set of one or more target user attributes;
in response to receiving the request, the computer system determining a selected item of UGC from a plurality of items of UGC, wherein the determining the selected item of UGC is based on:
one or more of the set of target user attributes; and
one or more of a set of one or more contributor attributes, wherein the set of contributor attributes corresponds to one or more characteristics of a contributor of the selected item of UGC; and
the computer system causing at least a portion of the selected item of UGC to be transmitted via a network.

2. The method of claim 1, wherein the determining the selected item of UGC is based on a plurality of the set of contributor attributes.

3. The method of claim 1, wherein the determining the selected item of UGC includes calculating a measure of a match of the contributor of the selected item of UGC to the one or more of the set of target user attributes.

4. The method of claim 3, wherein the match of the contributor is based on at least one of the set of target user attributes having a different value from a value for a corresponding one of the set of contributor attributes.

5. The method of claim 1, wherein the determining the selected item of UGC comprises matching values for individual ones of the set of target user attributes to values for individual ones of the set of contributor attributes.

6. The method of claim 5, wherein the matching includes using at least two different weighting values for two or more of the set of target user attributes.

7. The method of claim 5, wherein the matching includes using at least two different weighting values for two or more of the set of contributor attributes.

8. The method of claim 1, wherein the contributor of the selected item of UGC is an author of text comprising the at least a portion of the selected item of UGC.

9. The method of claim 1, wherein the determining the selected item of UGC is based on a plurality of the set of target user attributes.

10. The method of claim 1, wherein the causing the at least a portion of the selected item of UGC to be transmitted includes causing the at least a portion of the selected item of UGC to be included as part of an advertisement.

11. A computer-readable storage medium having stored thereon instructions that are executable by a computer system to cause the computer system to perform operations comprising:
receiving a request for user-generated content (UGC) to be provided as web content to a target user, wherein the target user is associated with a set of one or more target user attributes;
in response to receiving the request, determining a selected item of UGC from a plurality of items of UGC, wherein the determining the selected item of UGC is based on:
one or more of the set of target user attributes; and
one or more of a set of one or more contributor attributes, wherein the set of contributor attributes corresponds to one or more characteristics of a contributor of the selected item of UGC; and
causing at least a portion of the selected item of UGC to be transmitted via a network.

12. The computer-readable storage medium of claim 11, wherein the web content includes an advertisement, and wherein the operations further comprise causing the at least a portion of the selected item of UGC to be inserted into the advertisement.

13. The computer-readable storage medium of claim 11, wherein the web content includes at least a portion of a social media page, and wherein the operations further comprise causing the at least a portion of the selected item of UGC to be inserted into the at least a portion of the social media page.

14. The computer-readable storage medium of claim 11, wherein the determining the selected item of UGC includes calculating a measure of a match of the contributor of the selected item of UGC to the one or more of the set of target user attributes.

15. The computer-readable storage medium of claim 14, wherein calculating the measure of the match is based on a level of expertise indicated by a value for a first one of the set of contributor attributes.

16. The computer-readable storage medium of claim 11, wherein the determining the selected item of UGC comprises matching values for individual ones of the set of target user attributes to values for individual ones of the set of contributor attributes, and wherein the matching includes using at least two different weighting values for two or more of the set of target user attributes.

17. A computer system, comprising:
a processor;
a network interface configured to couple to a network; and
a computer-readable storage medium having stored thereon instructions that are executable by the computer system, using the processor, to cause the computer system to perform operations comprising:
receiving a request for user-generated content (UGC) to be provided as an advertisement as a portion of a web page transmitted to a target user, wherein the target user is associated with a set of one or more target user attributes;
in response to receiving the request, determining a selected item of UGC from a plurality of items of UGC, wherein the determining the selected item of UGC is based on:
one or more of the set of target user attributes; and
one or more of a set of one or more contributor attributes, wherein the set of contributor attributes corresponds to one or more characteristics of contributor of the selected item of UGC; and
causing at least a portion of the selected item of UGC to be transmitted via the network.

18. The computer system of claim 17, wherein the plurality of items of UGC are pre-selected based on one or more specified criteria from another set of items of UGC.

19. The computer system of claim 17, wherein the determining the selected item of UGC comprises matching values for individual ones of the set of target user attributes to values for individual ones of the set of contributor attributes, wherein the matching includes using at least two different weighting values for two or more of the set of contributor attributes.

20. The computer system of claim 17, wherein the advertisement is for a particular good or service.
